(19) United States
(12) Patent Application Publication
(10) Pub. No.: US 2023/0154250 A1
(43) Pub. Date: May 18, 2023

(54) Vehicle Fuel Economy Evaluation Method Based on Data Analysis

(71) Applicants: Zhejiang Feidi Motors Co., Ltd, Hangzhou (CN); Shandong Wuzheng Group Co., Ltd., Rizhao (CN)

(72) Inventors: Wenjuan Jiang, Rizhao (CN); Licheng Xu, Rizhao (CN); Zhen Cui, Rizhao (CN); Huiyi Wang, Rizhao (CN); Guibao Cao, Rizhao (CN); Dongtao Lu, Rizhao (CN); Minghua Zhang, Rizhao (CN)

(21) Appl. No.: 17/564,244

(22) Filed: Dec. 29, 2021

(30) Foreign Application Priority Data
Nov. 15, 2021 (CN) 202111344869.4

(51) Int. Cl. G07C 5/08; G06N 5/04; G06V 10/72; B60W 40/105; B60W 40/107; B60W 40/13

(52) U.S. Cl. CPC G07C 5/0808; G06N 5/04; G06V 10/72; B60W 40/105; B60W 40/107; B60W 40/13; B60W 2530/18; B60W 2510/10; B60W 2756/00

(57) ABSTRACT

Disclosed is a vehicle fuel economy evaluation method based on data analysis. The method combines data processing and a fuel model with an enhanced learning mechanism to predict fuel consumption, analyze driving behavior and output an improvement suggestion. With continuous enhanced learning and long-term dynamic improvement, the model will be able to predict economic fuel consumption in an increasingly accurate way, along with specific and intuitive driving behavior suggestions to help drivers to drive economically.

### CROSS REFERENCE TO RELATED APPLICATIONS

The present application claims the benefit of Chinese Patent Application No. 202111344869.4 filed on Nov. 15, 2021, the contents of which are incorporated herein by reference in their entirety.

### FIELD OF THE INVENTION

The present invention belongs to the technical field of vehicle-mounted machine system, in particular to a vehicle fuel economy evaluation method based on data analysis.

### BACKGROUND OF THE INVENTION

Automobile fuel economy refers to the ability of automobile to consume as little fuel as possible for economic driving while ensuring power. The automobile fuel cost is an important part of automobile transportation cost, and improving fuel economy is the key to saving automobile transportation cost.

Moreover, the yearly increase of car pare, the increasing shortage of petroleum and the increasingly stringent environmental protection regulations also require the improvement of fuel economy. Therefore, how to improve and utilize fuel economy has become a major concern for the whole society.

In addition to the automobile structure, including engine structure, curb mass and shape, the use mode of vehicle is also an important factor affecting the automobile fuel economy, among which the driver's operation behavior and the automobile working intensity are two important factors of automobile fuel consumption.

Therefore, based on big data and AI technology, it is necessary to analyze driver's operation behavior and vehicle working intensity by using vehicle travel data, and build a fuel consumption prediction model to improve fuel economy in terms of vehicle use.

Lots of fuel economy evaluation systems are currently available on the market, including a fuel economy evaluation method based on a vehicle's structure configuration, or a fuel economy evaluation method that requires road evaluation parameters and other parameters and weights to be preset subjectively, and a fuel economy evaluation method that compares the instantaneous fuel consumption calculated based on a universal characteristic diagram with the actual fuel consumption.

At present, the problems existing in the evaluation system of driver's operating behavior and fuel economy are as follows:

1. Existing related technologies lack the ability of long-term dynamic improvement of economy. It is suggested that long-term and short-term memory neural networks are used to save fuel consumption by analyzing and learning from updated data, which is computationally expensive, time-consuming and uneconomical in case of long time span and deep network level.

2. The evaluation system is affected by artificially preset road environment parameters and other parameters and weights.

3. The driving behavior advice is general and less targeted.

### SUMMARY OF THE INVENTION

The present invention provides a vehicle fuel economy evaluation method based on data analysis to solve the problems existing in the above background art.

In order to achieve the above purpose, the technical solution adopted by the present invention is a vehicle fuel economy evaluation method based on data analysis, which specifically includes the following steps:

step S1: data processing: parsing original message data sent by a vehicle terminal to obtain travel time, vehicle VIN code, load, engine speed, engine fuel flow, instantaneous fuel consumption, vehicle speed, engine net output torque percentage, accelerator pedal opening, clutch state and brake state data;

step S2: determining whether the mode is a training mode; if so, executing steps S3, S4 and S5 sequentially; if not, executing step S6;

step S3: building a training dataset and storing the training dataset in a configuration file;

step S4: pumping training data into a KNN-based model to build a fuel economy model;

step S5: deploying the model;

step S6: calculating an actual fuel index of a vehicle travel;

step S7: outputting a fuel consumption prediction result and a driving condition by a fuel model;

step S8: determining whether the travel is an economic travel according to the fuel consumption prediction result output in the step S7; if so, executing step S9; if not, executing step S10, and the process ends;

step S9: incremental learning;

step S10: non-incremental learning;

step S11: drawing a driving behavior image according to the driving condition output by the fuel model in the step S7;

step S12: determining whether a statistical index of working condition in the image exceeds a threshold; if so, executing step S13; if not, executing step S14;

step S13: outputting an improvement suggestion for driving behaviors;

step S14: no suggestion output.

Preferably, the step S1 specifically includes the following sub-steps:

sub-step S100: parsing original message data;

sub-step S101: data preprocessing, which refers to the definition and conversion of driving data field types and data normalization processing, specifically comprising:

1: defining and converting the travel time to a timestamp type;

2: converting the fields other than the travel time and the vehicle VIN code into digital types; and

3: normalizing a throttle opening;

sub-step S102: data cleaning, specifically comprising:

1: filtering outliers of vehicle speed, engine speed and instantaneous fuel consumption;

2: filtering the vehicle speed by a box chart method, and retaining only the data within a reasonable range; and

3: duplicating all other remaining data after setting the vehicle VIN code and the time stamp as indexes;

sub-step S103: data alignment, which refers to data filling and interpolation by linear interpolation or nearest interpolation;

sub-step S104: data precision restriction, which refers to the retention of several decimal places in the data according to the data precision requirements;

sub-step S105: gear recognition, which refers to gear recognition based on speed ratio intervals, each speed ratio interval corresponding to a gear; and

sub-step S106: generating a derived characteristic, which refers to the calculation of acceleration according to the speed and time, in m/s².

Preferably, the step S3 building a training dataset and storing the training dataset in a configuration file, requires the travel data to be spitted at small intervals and an interval average value to be calculated, aiming to reduce the amount of data used as the training dataset and thus optimize the model efficiency; a processing method specifically comprising:

three variables (speed, acceleration and load) in the travel data being spitted at small intervals: the speed is spitted at an interval of 1 km/h, the acceleration is spitted at an interval of 0.1 m/s², and the load is spitted at an interval of 500 kg; according to the method of spitting the travel data at small intervals and calculating an interval average value, multiple driving data within the same small interval being embodied as one driving data by adopting the interval average value method, thus achieving the purpose of reducing the amount of data in the dataset, and then storing the built dataset into a model configuration file.

Preferably, the step S4 pumping training data into a KNN-based model to build a fuel economy model, specifically comprises the following steps:

pumping the training dataset into a K Neighbors Regressor (KNN) model in a python machine learning scikit-learn library, and adjusting the model according to appropriate parameters; an arithmetic average method being adopted to assign equal weight to each neighbor, complete the construction of a fuel model, and learn and count the average engine fuel flow of an economic driving behavior according to certain speed, acceleration and load conditions.

Preferably, the step S5 deploying the model, specifically comprises the following steps:

deploying the fuel model and a configuration file thereof to a cloud server, building a Docker image with a service code, and pushing the mirror image to a Docker image repository of the Internet of Vehicles; in an Internet of Vehicles cloud platform, an service image in the Docker image repository automatically creating a Docker container according to the set rules, and providing an API access interface of the model service for a caller; and the API access interface being able to call fuel model service, and returning a fuel consumption prediction result and a driving behavior improvement suggestion result to the caller.

Preferably, the step S6 calculating an actual fuel index of a vehicle travel, has the following fuel indexes to be calculated on the basis of the travel data processed in the step S1:

instantaneous fuel consumption per 100 km (L/100 km)=engine fuel flow (L/H)/vehicle speed (km/H)*100;

instantaneous fuel consumption per 100 km ton (L/100t*km)=instantaneous fuel consumption per 100 km (L/100 km)/load(t);

power=engine speed*engine net output torque percentage/9550;

engine fuel consumption rate=engine fuel flow/power;

average fuel consumption per 100 km is an average value of all instantaneous fuel consumption per 100 km;

average fuel consumption per 100 km ton is an average value of all instantaneous fuel consumption per 100 km ton;

an average fuel consumption rate is an average value of all fuel consumption rates.

Preferably, the step S7 outputs a fuel consumption prediction result and a driving condition by a fuel model:

the fuel model outputs the fuel consumption prediction results specifically in the following steps:

on the basis of a current fuel model, inputting test travel data into the current fuel model, and triggering the nearest neighbor matching mechanism, so as to estimate the average most economical engine fuel flow of the travel; according to the instantaneous engine fuel flow estimated by the current fuel model, calculating a fuel consumption per 100 km, an average fuel consumption per 100 km and an average fuel consumption rate under economic conditions , and outputting the fuel consumption prediction result;

the fuel model outputs the driving conditions specifically in the following steps:

driving condition extraction: based on the original message data parsed in the step S1 sent by a vehicle terminal, identifying a working condition by combining the travel data with acceleration, throttle opening, brake clutch state, minimum duration of working condition, maximum interval duration of the same working condition, gear and engine speed;

a driving condition identified by the method comprises:

acceleration, deceleration, rapid acceleration, rapid deceleration, uniform speed, start, stop, small throttle, medium throttle, large throttle, full throttle, idle speed, skidding, gear shift, braking, depressing clutch, near external characteristic curve, full throttle at low speed, high gear at low speed, high gear at high speed, skipped gear shift, and rapid acceleration at start.

Preferably, the step S8 determining whether the travel is an economic travel, by the specific rules as follows:

the average fuel consumption per 100 km is entered into the fuel model and compared with the fuel consumption per 100 km predicted by the fuel model; if the average fuel consumption per 100 km predicted by the fuel model is greater than the average fuel consumption per 100 km calculated in the actual fuel index of a vehicle travel, the travel is determined to be an economic travel, and then the step S9 incremental learning is executed.

Preferably, the step S9 incremental learning specifically comprises the following steps:

fusing economic travel data with the training data stored in the current fuel model, superimposing and building the same into a latest training dataset, and updating a configuration file of the current fuel model for use in the next time when the test data calls the model and a configuration file thereof.

Preferably, the step S11 specifically comprises the following sub-steps:

sub-step S110: making basic feature statistics on the travel data, specifically comprising a VIN code, a load, an accumulated mileage, total travel time, accumulated engine fuel flow, actual fuel consumption per 100 km, average fuel consumption per 100 km and an average fuel consumption rate;

sub-step S111: making statistics on the distribution characteristics of important variables in the travel data, specifically comprising distribution statistics of an engine net output torque percentage, an acceleration, an engine speed, a speed and throttle opening, and state statistics of a brake, a clutch and a gear;

the distribution statistics of the engine net output torque percentage, the acceleration, the engine speed, the speed and throttle opening being the maximum, average and minimum values thereof;

the state statistics of a brake, a clutch, and a gear being the statistics of the frequency thereof;

sub-step S112: according to all the driving conditions output by the fuel model in the step S7, making statistics on characteristics of specific driving behaviors under each driving condition, specifically comprising frequency of a driving condition, duration of single driving condition, a time interval between two consecutive driving conditions, longest duration of single driving condition, a longest time interval between two consecutive driving conditions, frequency (every 10 minutes on average), a ratio of duration of driving condition to travel time, cumulative duration of driving conditions, a cumulative mileage of driving conditions, and fuel consumption under a working condition;

The fuel consumption under a working condition comprising cumulative fuel consumption, actual fuel consumption per 100 km, average fuel consumption per 100 km and average fuel consumption rate under a certain working condition.

The above technical solution has the following advantageous effects:

1. The vehicle fuel economy evaluation method based on data analysis in the present invention has an enhanced learning mechanism, which can achieve economic long-term dynamic improvement by only continuing to learn the driving data of the economic travel, and realizing the balance point with the greatest utility in stability-plasticity under the condition of limited calculation and storage resources. The stability refers to the prevention of significant interference of new data with existing knowledge; while the plasticity refers to the ability to integrate new knowledge and refine existing knowledge from new data.

2. According to the vehicle fuel economy evaluation method based on data analysis of the present invention, the fuel model has a multi-process mode, which can further improve the calculation and operation efficiency of the fuel model.

3. The vehicle fuel economy evaluation method based on data analysis of the present invention can predict fuel consumption more accurately, without relying on the influence of artificially preset road environmental parameters.

4. The vehicle fuel economy evaluation method based on data analysis of the present invention can determine all working conditions in the travel and give concrete and intuitive suggestions for bad driving behaviors of drivers in a single working condition. For example, if frequent braking occurs during the travel, the driver will be reminded of how many times frequent braking occurs to attract the driver's attention.

5. According to the vehicle fuel economy evaluation method based on data analysis of the present invention, with continuous enhanced learning and long-term dynamic improvement, the model will be able to predict economic fuel consumption in an increasingly accurate way, along with specific and intuitive driving behavior suggestions to help drivers to drive economically.

### BRIEF DESCRIPTION OF THE DRAWINGS

FIG. 1 is a logical block diagram of the vehicle fuel economy evaluation method based on data analysis according to the present invention.

FIG. 2 is a logical block diagram of data processing.

FIG. 3 is a logical block diagram of a driving behavior image.

### DETAILED DESCRIPTION OF THE PREFERRED EMBODIMENTS

The specific embodiments of the present invention will be further described in detail below with reference to drawings and the description of embodiments, aiming to help those skilled in the art to have a more complete, accurate and in-depth understanding of the concept and technical solution of the present invention and contributing to the implementation thereof.

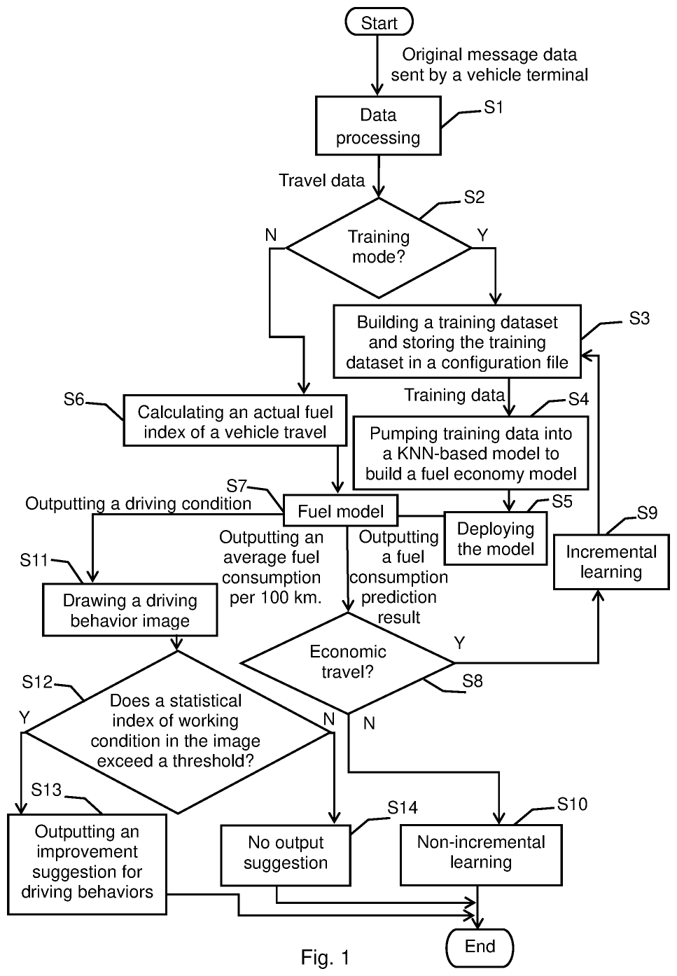

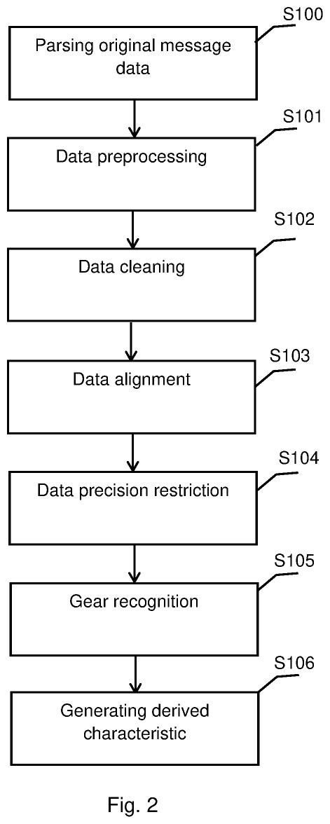

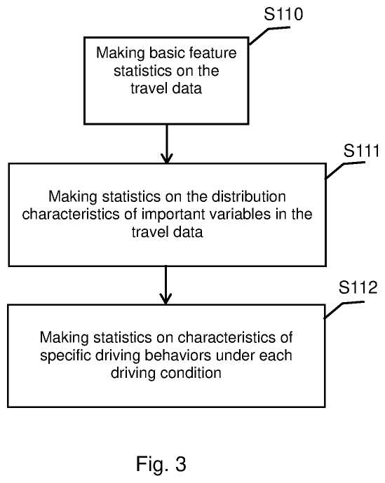

As shown in FIG. 1 to FIG. 3, the present invention provides a vehicle fuel economy evaluation method based on data analysis. With continuous enhanced learning and long-term dynamic improvement, the model will be able to predict economic fuel consumption in an increasingly accurate way, along with specific and intuitive driving behavior suggestions to help drivers to drive economically.

### Embodiment 1

step S1: data processing: parsing original message data sent by a vehicle terminal to obtain travel time, vehicle VIN code, load, engine speed, engine fuel flow, instantaneous fuel consumption, vehicle speed, engine net output torque percentage, accelerator pedal opening, clutch state and brake state data;

step S2: determining that the mode is a training mode, and executing the steps S3, S4 and S5 sequentially;

step S3: building a training dataset and storing the training dataset in a configuration file;

step S4: pumping training data into a KNN-based model to build a fuel economy model;

step S5: deploying the model;

the step S3 building a training dataset and storing the training dataset in a configuration file, requires the travel data to be spitted at small intervals and an interval average value to be calculated, aiming to reduce the amount of data used as the training dataset and thus optimize the model efficiency; a processing method specifically comprising:

Three variables (speed, acceleration and load) in the travel data are spitted at small intervals: the speed is spitted at an interval of 1 km/h, the acceleration is spitted at an interval of 0.1 m/s², and the load is spitted at an interval of 500 kg; for example, speed of 0-1 km/h, acceleration of 0-0.1 m/s² and load of 0-500 kg can be regarded as one interval; while speed of 1-2 km/h, acceleration of 0.1-0.2 m/s² and load of 500-1000 kg can be regarded as another small interval. The engine fuel flow value and three variable values, i.e. vehicle speed value, acceleration value and load value, in each small interval are counted and represented by the mean value. According to the method of spitting the travel data at small intervals and calculating an interval average value, multiple driving data within the same small interval are embodied as one driving data by adopting the interval average value method, thus achieving the purpose of reducing the amount of data in the dataset, and then storing the built dataset into a model configuration file.

the step S4 pumping training data into a KNN-based model to build a fuel economy model, specifically comprises the following steps:

pumping the training dataset into a K Neighbors Regressor (KNN) model in a python machine learning scikit-learn library, and adjusting the model according to appropriate parameters; an arithmetic average method being adopted to assign equal weight to each neighbor, complete the construction of a fuel model, and learn and count the average engine fuel flow of an economic driving behavior according to certain speed, acceleration and load conditions.

the step S5 deploying the model, specifically comprises the following steps:

deploying the fuel model and a configuration file thereof to a cloud server, building a Docker image with a service code, and pushing the mirror image to a Docker image repository of the Internet of Vehicles; in an Internet of Vehicles cloud platform, an service image in the Docker image repository automatically creating a Docker container according to the set rules, and providing an API access interface of the model service for a caller; and the API access interface being able to call fuel model service, and returning a fuel consumption prediction result and a driving behavior improvement suggestion result to the caller.

### Embodiment 2

step S1: data processing: parsing original message data sent by a vehicle terminal to obtain travel time, vehicle VIN code, load, engine speed, engine fuel flow, instantaneous fuel consumption, vehicle speed, engine net output torque percentage, accelerator pedal opening, clutch state and brake state data;

step S2: determining that the mode is not a training mode, and executing the step S6;

step S6: calculating an actual fuel index of a vehicle travel;

step S7: outputting a fuel consumption prediction result and a driving condition by a fuel model;

step S8: determining whether the travel is an economic travel according to the fuel consumption prediction result output in the step S7; if so, executing step S9; if not, executing step S10, and the process ends;

step S9: incremental learning;

step S10: end of non-incremental learning.

the step S6 calculating an actual fuel index of a vehicle travel, has the following fuel indexes to be calculated on the basis of the travel data processed in the step S1:

Instantaneous fuel consumption per 100 km (L/100 km)=engine fuel flow (L/H)/vehicle speed (km/H)*100;

Instantaneous fuel consumption per 100 km ton (L/100t*km)=instantaneous fuel consumption per 100 km (L/100 km)/load(t);

Power=engine speed*engine net output torque percentage/9550;

Engine fuel consumption rate=engine fuel flow/power;

Average fuel consumption per 100 km is an average value of all instantaneous fuel consumption per 100 km;

Average fuel consumption per 100 km ton is an average value of all instantaneous fuel consumption per 100 km ton;

An average fuel consumption rate is an average value of all fuel consumption rates.

the step S7 outputs a fuel consumption prediction result and a driving condition by a fuel model:

The fuel model outputs the fuel consumption prediction results specifically in the following steps:

on the basis of a current fuel model, inputting test travel data into the current fuel model, and triggering the nearest neighbor matching mechanism, so as to estimate the average most economical engine fuel flow of the travel; according to the instantaneous engine fuel flow estimated by the current fuel model, calculating a fuel consumption per 100 km, an average fuel consumption per 100 km and an average fuel consumption rate under economic conditions, and outputting the fuel consumption prediction result;

the step S8 determining whether the travel is an economic travel, by the specific rules as follows:

the average fuel consumption per 100 km is entered into the fuel model and compared with the fuel consumption per 100 km predicted by the fuel model; if the average fuel consumption per 100 km predicted by the fuel model is greater than the average fuel consumption per 100 km calculated in the actual fuel index of a vehicle travel, the travel is determined to be an economic travel, and then the step S9 incremental learning is executed.

the step S9 incremental learning specifically comprises the following steps:

fusing economic travel data with the training data stored in the current fuel model, superimposing and building the same into a latest training dataset, and updating a configuration file of the current fuel model for use in the next time when the test data calls the model and a configuration file thereof.

### Embodiment 3

The fuel model outputs the driving conditions specifically in the following steps:

driving condition extraction: based on the original message data parsed in the step S1 sent by a vehicle terminal, identifying a working condition by combining the travel data with acceleration, throttle opening, brake clutch state, minimum duration of working condition, maximum interval duration of the same working condition, gear and engine speed;

A driving condition identified by the method comprises:

acceleration, deceleration, rapid acceleration, rapid deceleration, uniform speed, start, stop, small throttle, medium throttle, large throttle, full throttle, idle speed, skidding, gear shift, braking, depressing clutch, near external characteristic curve, full throttle at low speed, high gear at low speed, high gear at high speed, skipped gear shift, and rapid acceleration at start.

step S11: drawing a driving behavior image according to the driving condition output by the fuel model in the step S7;

step S12: determining whether a statistical index of working condition in the image exceeds a threshold; if so, executing step S13; if not, executing step S14;

step S13: outputting an improvement suggestion for driving behaviors;

step S14: no suggestion output.

the step S11 specifically comprises the following sub-steps:

sub-step S110: making basic feature statistics on the travel data, specifically comprising a VIN code, a load, an accumulated mileage, total travel time, accumulated engine fuel flow, actual fuel consumption per 100 km, average fuel consumption per 100 km and an average fuel consumption rate;

sub-step S111: making statistics on the distribution characteristics of important variables in the travel data, specifically comprising distribution statistics of an engine net output torque percentage, an acceleration, an engine speed, a speed and throttle opening, and state statistics of a brake, a clutch and a gear;

the distribution statistics of the engine net output torque percentage, the acceleration, the engine speed, the speed and throttle opening being the maximum, average and minimum values thereof;

The state statistics of a brake, a clutch, and a gear being the statistics of the frequency thereof;

sub-step S112: according to all the driving conditions output by the fuel model in the step S7, making statistics on characteristics of specific driving behaviors under each driving condition, specifically comprising frequency of a driving condition, duration of single driving condition, a time interval between two consecutive driving conditions, longest duration of single driving condition, a longest time interval between two consecutive driving conditions, frequency (every 10 minutes on average), a ratio of duration of driving condition to travel time, cumulative duration of driving conditions, a cumulative mileage of driving conditions, and fuel consumption under a working condition;

The fuel consumption under a working condition comprising cumulative fuel consumption, actual fuel consumption per 100 km, average fuel consumption per 100 km and average fuel consumption rate under a certain working condition.

The present invention has been exemplarily described with reference to drawings. Obviously, the concrete realization of the present invention is not limited above, and non-substantial improvements made by using the method concept and technical solution of the present invention, or direct application of the above ideas and technical solutions of the present invention to other occasions without improvement, shall fall within the scope of protection of the present invention.

What is claimed is:

1. A vehicle fuel economy evaluation method based on data analysis, comprising the following steps:
step S1: data processing: parsing original message data sent by a vehicle terminal to obtain travel time, vehicle VIN code, load, engine speed, engine fuel flow, instantaneous fuel consumption, vehicle speed, engine net output torque percentage, accelerator pedal opening, clutch state and brake state data;
step S2: determining whether the mode is a training mode; if so, executing steps S3, S4 and S5 sequentially; if not, executing step S6;
step S3: building a training dataset and storing the training dataset in a configuration file;
step S4: pumping training data into a KNN-based model to build a fuel economy model;
step S5: deploying the model;
step S6: calculating an actual fuel index of a vehicle travel;
step S7: outputting a fuel consumption prediction result and a driving condition by a fuel model;
step S8: determining whether the travel is an economic travel according to the fuel consumption prediction result output in the step S7; if so, executing step S9; if not, executing step S10, and the process ends;
step S9: incremental learning;
step S10: non-incremental learning;
step S11: drawing a driving behavior image according to the driving condition output by the fuel model in the step S7;
step S12: determining whether a statistical index of working condition in the image exceeds a threshold; if so, executing step S13; if not, executing step S14;
step S13: outputting an improvement suggestion for driving behaviors;
step S14: no suggestion output.

2. The vehicle fuel economy evaluation method based on data analysis according to claim 1, wherein the step S1 specifically comprises the following sub-steps:
sub-step S100: parsing original message data;
sub-step S101: data preprocessing, which refers to the definition and conversion of driving data field types and data normalization processing, specifically comprising:
1): defining and converting the travel time to a timestamp type;
2): converting the fields other than the travel time and the vehicle VIN code into digital types; and
3): normalizing a throttle opening;
sub-step S102: data cleaning, specifically comprising:
1): filtering outliers of vehicle speed, engine speed and instantaneous fuel consumption;
2): filtering the vehicle speed by a box chart method, and retaining only the data within a reasonable range; and
3): duplicating all other remaining data after setting the vehicle VIN code and the time stamp as indexes;
sub-step S103: data alignment, which refers to data filling and interpolation by linear interpolation or nearest interpolation;
sub-step S104: data precision restriction, which refers to the retention of several decimal places in the data according to the data precision requirements;
sub-step S105: gear recognition, which refers to gear recognition based on speed ratio intervals, each speed ratio interval corresponding to a gear; and
sub-step S106: generating a derived characteristic, which refers to the calculation of acceleration according to the speed and time, in m/s².

3. The vehicle fuel economy evaluation method based on data analysis according to claim 1, wherein the step S3 building a training dataset and storing the training dataset in a configuration file, requires the travel data to be spitted at small intervals and an interval average value to be calculated, aiming to reduce the amount of data used as the training dataset and thus optimize the model efficiency; a processing method specifically comprising:
three variables (speed, acceleration and load) in the travel data being spitted at small intervals: the speed is spitted at an interval of 1 km/h, the acceleration is spitted at an interval of 0.1 m/s², and the load is spitted at an interval of 500 kg; according to the method of spitting the travel data at small intervals and calculating an interval average value, multiple driving data within the same small interval being embodied as one driving data by adopting the interval average value method, thus achieving the purpose of reducing the amount of data in the dataset, and then storing the built dataset into a model configuration file.

4. The vehicle fuel economy evaluation method based on data analysis according to claim 1, wherein the step S4 pumping training data into a KNN-based model to build a fuel economy model, specifically comprises the following steps:
pumping the training dataset into a K Neighbors Regressor (KNN) model in a python machine learning scikit-learn library, and adjusting the model according to appropriate parameters; an arithmetic average method being adopted to assign equal weight to each neighbor, complete the construction of a fuel model, and learn and count the average engine fuel flow of an economic driving behavior according to certain speed, acceleration and load conditions.

5. The vehicle fuel economy evaluation method based on data analysis according to claim 1, wherein the step S5 deploying the model, specifically comprises the following steps:
deploying the fuel model and a configuration file thereof to a cloud server, building a Docker image with a service code, and pushing the mirror image to a Docker image repository of the Internet of Vehicles; in an Internet of Vehicles cloud platform, an service image in the Docker image repository automatically creating a Docker container according to the set rules, and providing an API access interface of the model service for a caller; and the API access interface being able to call fuel model service, and returning a fuel consumption prediction result and a driving behavior improvement suggestion result to the caller.

6. The vehicle fuel economy evaluation method based on data analysis according to claim 1, wherein the step S6 calculating an actual fuel index of a vehicle travel, has the following fuel indexes to be calculated on the basis of the travel data processed in the step S1:
instantaneous fuel consumption per 100 km (L/100 km)=engine fuel flow (L/H)/vehicle speed (km/H)*100;
instantaneous fuel consumption per 100 km ton (L/100t*km)=instantaneous fuel consumption per 100 km (L/100 km)/load(t);
power=engine speed*engine net output torque percentage/9550;
engine fuel consumption rate=engine fuel flow/power;
average fuel consumption per 100 km is an average value of all instantaneous fuel consumption per 100 km;
average fuel consumption per 100 km ton is an average value of all instantaneous fuel consumption per 100 km ton;
an average fuel consumption rate is an average value of all fuel consumption rates.

7. The vehicle fuel economy evaluation method based on data analysis according to claim 1, wherein the step S7 outputs a fuel consumption prediction result and a driving condition by a fuel model:
the fuel model outputs the fuel consumption prediction results specifically in the following steps:
on the basis of a current fuel model, inputting test travel data into the current fuel model, and triggering the nearest neighbor matching mechanism, so as to estimate the average most economical engine fuel flow of the travel; according to the instantaneous engine fuel flow estimated by the current fuel model, calculating a fuel consumption per 100 km, an average fuel consumption per 100 km and an average fuel consumption rate under economic conditions, and outputting the fuel consumption prediction result;
the fuel model outputs the driving conditions specifically in the following steps:
driving condition extraction: based on the original message data parsed in the step S1 sent by a vehicle terminal, identifying a working condition by combining the travel data with acceleration, throttle opening, brake clutch state, minimum duration of working condition, maximum interval duration of the same working condition, gear and engine speed;
a driving condition identified by the method comprises:
acceleration, deceleration, rapid acceleration, rapid deceleration, uniform speed, start, stop, small throttle, medium throttle, large throttle, full throttle, idle speed, skidding, gear shift, braking, depressing clutch, near external characteristic curve, full throttle at low speed, high gear at low speed, high gear at high speed, skipped gear shift, and rapid acceleration at start.

8. The vehicle fuel economy evaluation method based on data analysis according to claim 1, wherein the step S8 determines whether the travel is an economic travel, by the specific rules as follows:
the average fuel consumption per 100 km is entered into the fuel model and compared with the fuel consumption per 100 km predicted by the fuel model; if the average fuel consumption per 100 km predicted by the fuel model is greater than the average fuel consumption per 100 km calculated in the actual fuel index of a vehicle travel, the travel is determined to be an economic travel, and then the step S9 incremental learning is executed.

9. The vehicle fuel economy evaluation method based on data analysis according to claim 1, wherein the step S9 incremental learning specifically comprises the following steps:
fusing economic travel data with the training data stored in the current fuel model, superimposing and building the same into a latest training dataset, and updating a configuration file of the current fuel model for use in the next time when the test data calls the model and a configuration file thereof.

10. The vehicle fuel economy evaluation method based on data analysis according to claim 1, wherein the step S11 specifically comprises the following sub-steps:
sub-step S110: making basic feature statistics on the travel data, specifically comprising a VIN code, a load, an accumulated mileage, total travel time, accumulated engine fuel flow, actual fuel consumption per 100 km, average fuel consumption per 100 km and an average fuel consumption rate;
sub-step S111: making statistics on the distribution characteristics of important variables in the travel data, specifically comprising distribution statistics of an engine net output torque percentage, an acceleration, an engine speed, a speed and throttle opening, and state statistics of a brake, a clutch and a gear;
the distribution statistics of the engine net output torque percentage, the acceleration, the engine speed, the speed and throttle opening being the maximum, average and minimum values thereof;
the state statistics of a brake, a clutch, and a gear being the statistics of the frequency thereof;
sub-step S112: according to all the driving conditions output by the fuel model in the step S7, making statistics on characteristics of specific driving behaviors under each driving condition, specifically comprising frequency of a driving condition, duration of single driving condition, a time interval between two consecutive driving conditions, longest duration of single driving condition, a longest time interval between two consecutive driving conditions, frequency (every 10 minutes on average), a ratio of duration of driving condition to travel time, cumulative duration of driving conditions, a cumulative mileage of driving conditions, and fuel consumption under a working condition;
the fuel consumption under a working condition comprising cumulative fuel consumption, actual fuel consumption per 100 km, average fuel consumption per 100 km and average fuel consumption rate under a certain working condition.
